(19) United States
(12) Patent Application Publication
(10) Pub. No.: US 2004/0046742 A1
(43) Pub. Date: Mar. 11, 2004

(54) Keyboard for tablet computers

(76) Inventor: DeAnna Johnson, Eagle, ID (US)

Correspondence Address: HEWLETT-PACKARD COMPANY, Intellectual Property Administration, P.O. Box 272400, Fort Collins, CO, 80527-2400, US

(21) Appl. No.: 10/236,409

(22) Filed: Sep. 6, 2002

(51) Int. Cl. G09G 5/00

(52) U.S. Cl. 345/168; 345/179

(57) ABSTRACT

A method and system of entering data to a tablet computer can be created by displaying an image of a keyboard on a display of the computer and receiving user input through the image of the keyboard. The tablet computer preferably includes a memory unit that contains a driver for driving the display to display the image of the keyboard and a processor that runs the driver for displaying the image of the keyboard.

### FIELD OF THE INVENTION

The present invention relates to tablet computers. More specifically, the present invention relates to a keyboard for a tablet computer displayed on the computer's display.

### BACKGROUND OF THE INVENTION

Computers are widely used by most businesses and by many individuals to keep records, communicate, produce documents, and otherwise manage information. Laptop computers and personal digital assistants (PDAs) have been used to allow people to accomplish these computing needs away from their homes or offices.

A new kind of computing device, called a tablet computer, is a fully-equipped portable personal computer that allows the user to take notes in natural handwriting with a stylus, or digital pen, on a sensitive touch screen instead of requiring the use of a keyboard. The touch screen is much larger than those commonly used on PDAs. The tablet computer is designed to be the user's primary personal computer as well as a note-taking device, thus combining, in a sense, the functions of the laptop and PDA.

The tablet computer uses what is called digital ink. Digital ink allows the user to write a note on the screen in freehand just as the user would write on a piece of paper. Writing can be natural rather than being required to match a pattern. The note can be edited and revised using the stylus and even indexed and searched. The note stays in “ink” or handwritten form until the user translates the note into a text document. The recognition of handwritten notes and instructions is designed to be as reliable as input from a keyboard or mouse.

Frequently, however, the user desires the convenience of a standard keyboard with the tablet computer. One solution is to attach an external physical keyboard to the tablet computer. However, this can be inconvenient and burdensome to the user. In addition, many users desire a keyboard input method that is quiet, inconspicuous, and that does not take up space so that they can use it in meetings or other events where they do not desire to distract others.

Some PDAs include touch screen keyboards that require a pointing device because they are too small for fingers. This is also somewhat inconvenient and inefficient because the keypads cannot accept the pace of input achieved by standard typing. Additionally, the use of a pointing device with a touch screen keyboard is obviously quite tedious and not suitable for note taking.

### SUMMARY OF THE INVENTION

In one of many possible embodiments, the present invention provides a tablet computer, which displays on a display an image of a keyboard with images of individual keys. The tablet computer preferably includes a memory unit that contains a driver for driving the display to display the image of the keyboard and a processor that runs the driver for displaying the image of the keyboard.

Another embodiment of the present invention provides a method of entering data to a tablet computer. The method preferably comprises displaying an image of a keyboard on a display of the computer and receiving user input through the image of the keyboard.

Additional advantages and novel features of the invention will be set forth in the description which follows or may be learned by those skilled in the art through reading these materials or practicing the invention. The advantages of the invention may be achieved through the means recited in the attached claims.

### BRIEF DESCRIPTION OF THE DRAWINGS

The accompanying drawings illustrate preferred embodiments of the present invention and are a part of the specification. Together with the following description, the drawings demonstrate and explain the principles of the present invention. The illustrated embodiments are examples of the present invention and do not limit the scope of the invention.

FIG. 1 is a basic block diagram of a tablet computer incorporating an embodiment of the present invention.

FIG. 2 is a diagram of a frontal view of a tablet computer incorporating an embodiment of the present invention.

FIG. 3 is a diagram of a frontal view of a tablet computer with a touch screen keyboard and a text display window showing in the touch screen display according to an embodiment of the present invention.

FIG. 4 is a diagram of a touch screen keyboard according to an embodiment of the present invention.

FIG. 5 is a diagram of a frontal view of a tablet computer with an expanded touch screen keyboard (without the number pad) and a text display window showing in the touch screen display according to an embodiment of the present invention.

FIG. 6 is a diagram of a side view of a tablet computer with keyboard pads and a clear plastic layering according to embodiments of the present invention.

Throughout the drawings, identical reference numbers designate similar, but not necessarily identical, elements.

### DETAILED DESCRIPTION OF THE PREFERRED EMBODIMENTS

The present invention provides a method and system whereby a touch screen keyboard is used with a tablet computer. The keyboard is displayed on the existing touch screen of the tablet computer. The keyboard takes input from standard typing methods. The user may type with his or her fingers, or with a pointing device such as a stylus. The setup of the keyboard is preferably in standard keyboard layout. In addition, a window is displayed on the touch screen display in which the user can view and edit the text input.

Using the drawings, the preferred embodiments of the present invention will now be explained.

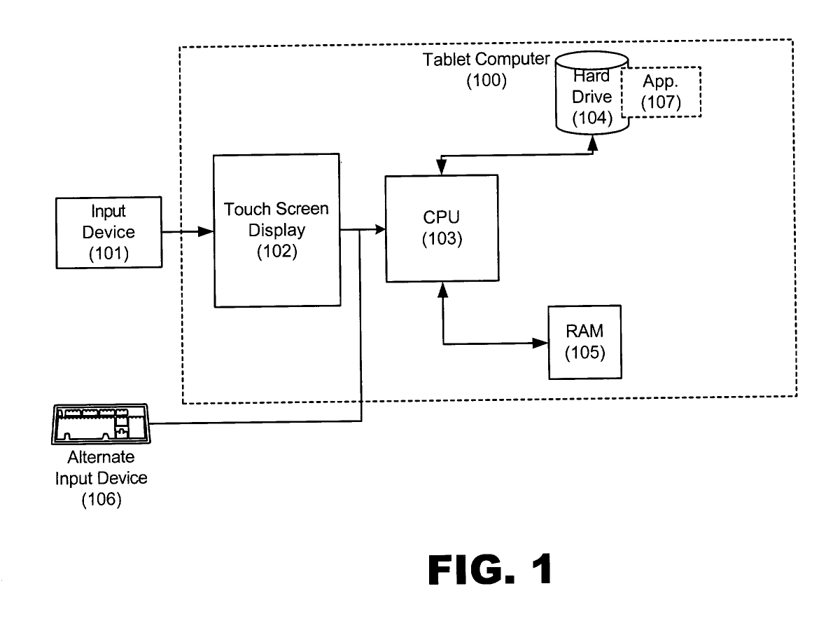

FIG. 1 is a basic block diagram of a tablet computer (100), which can be used to implement the present invention. As shown in FIG. 1, an input device (101) interacts with a touch screen display (102). The input device (101) maybe a stylus, finger, or any other pointing device that can operate the touch screen display (102).

There are many possible methods of interaction between the input device (101) and the touch screen display (102). For example, the input device (101) can be used to touch and select an icon or button that is displayed in the touch screen display (102) and that is programmed to invoke a specific function. Another example of interaction between the input device (101) and the touch screen display (102) is that user can use the input device (101) as a writing instrument and write in freehand on the touch screen display (102).

Returning to FIG. 1, the information that is input into the touch screen display (102) by the input device (101) is then input to a central processing unit (CPU) (103). The CPU (103) interprets and processes the input information. Because a tablet computer (100) is designed to function like a regular personal computer, the processed information can then be stored on a hard drive (104), kept in a random access memory (RAM) (105) for immediate use, or used in some other way, such as on a floppy disk or a compact disk (CD).

An alternate input device (106) may also be used in connection with the tablet computer (100). This alternate input device (106) could include a keyboard, mouse, or other device that bypasses the interactive touch screen display (102). The input information from an alternate input device (106) is processed by the CPU (103) using the same method as was used to process the information input through the touch screen display (102). The present invention, however, eliminates the need for a keyboard to be used as an alternate input device (106).

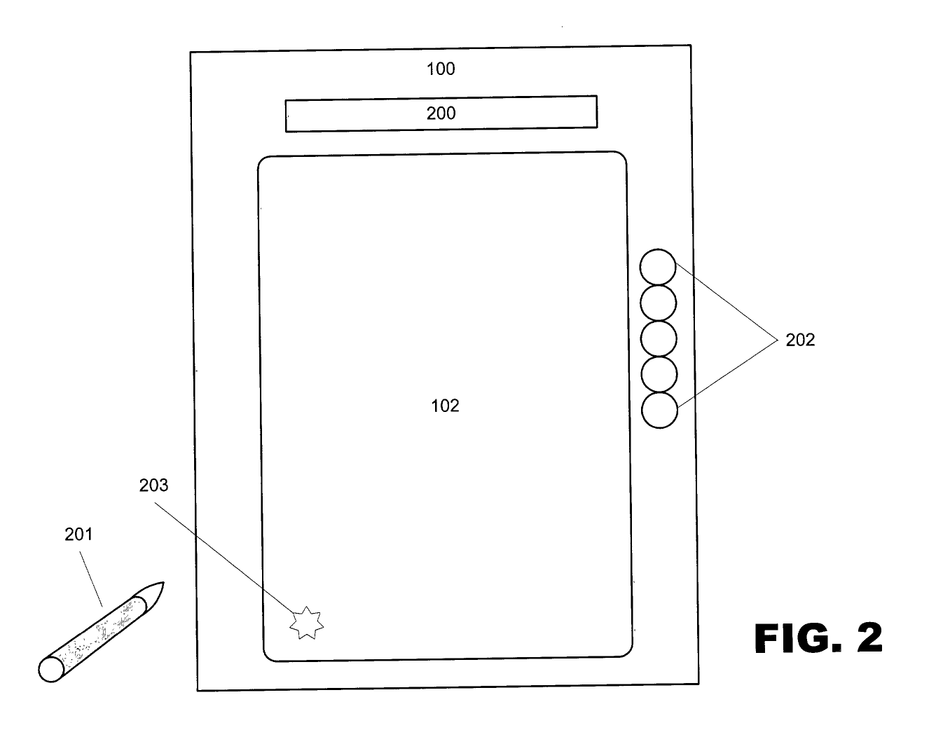

FIG. 2 is a diagram of a frontal view of a tablet computer (100), which can be used to implement the present invention. It preferably consists of a pointing device holder (200), a pointing device (201), which is a type of an input device (101; FIG. 1), a touch screen display (102), and a number of utility buttons (202). These utility buttons (202) could include power and reset buttons, for example.

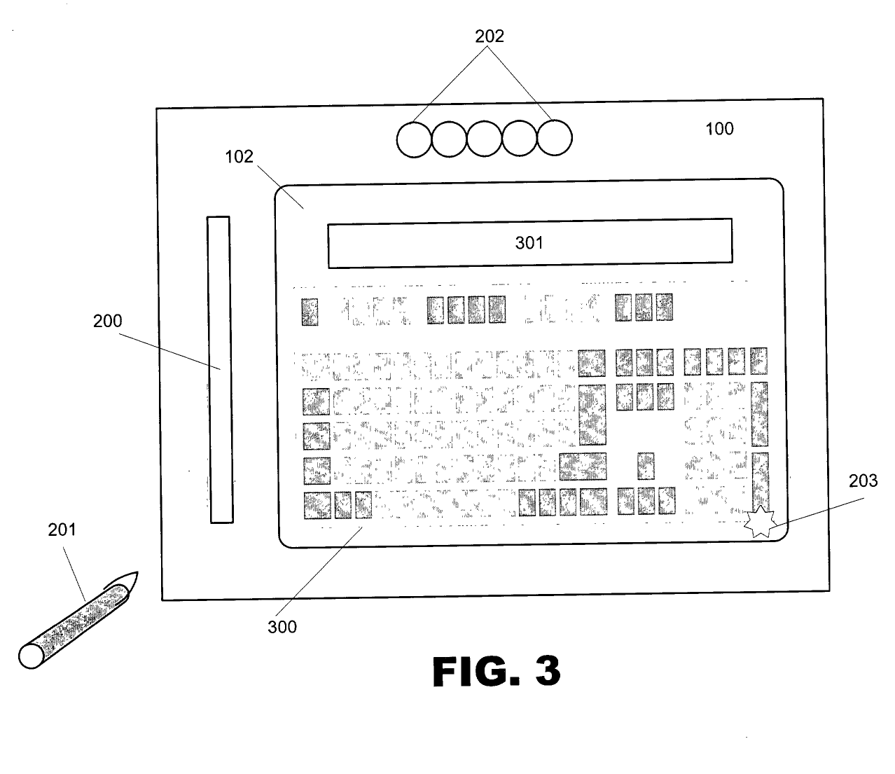

FIG. 3 is a diagram of an embodiment of the present invention. The user issues a command to the tablet computer (100) indicating that the use of a touch screen keyboard (300) is desired. This command can be issued by selecting a control mechanism, such as a utility button (202) or an icon (203) displayed on the touch screen display (102). A variety of other methods of issuing this command could also be used, such as the user making a specific stroke on the touch screen display (102) with a pointing device (201, FIG. 1).

Once the command is issued indicating that the use of a touch screen keyboard (300) is desired, the CPU (103; FIG. 1) preferably loads and executes an application, or driver, (107; FIG. 1) present on the hard drive (104; FIG. 1). This application (107; FIG. 1) is a program that displays the image of a keyboard (300) on the touch screen display (102). Running an application (107; FIG. 1) stored on a hard drive (104; FIG. 1) is not the only method that could be used to provide the touch screen keyboard (300) on the touch screen display (102). For example, a touch screen keyboard (300) application could be stored in a variety of integrated circuits (ICs) that could be placed in the tablet computer (100).

As shown in FIG. 3, the touch screen keyboard (300) is displayed in the touch screen display (102) and is preferably large enough to enable the user to type using his or her fingers (a type of input device (101; FIG. 1)) in typical keyboard strokes. The size of the touch screen keyboard (300) could vary with different tablet computers (100). An exemplary size would be that the touch screen keyboard (300) occupies 80 percent of the touch screen display (102).

However, the present invention also entails a method and a system whereby the size of the touch screen keyboard (300) is adjusted by the user. For example, the user might want the touch screen keyboard (300) to occupy almost 100 percent of the touch screen display (102). On the other hand, the user might want the touch screen keyboard (300) to occupy a much smaller fraction of the touch screen display (102).

The user can preferably adjust the size of the touch screen keyboard (300) using a number of different methods. For example, the user could adjust the size of the touch screen keyboard (300) by dragging the corner or edge of the touch screen keyboard (300) in or out with a pointing device (201), as is done in a variety of operating systems on a personal computer. The user could also select a control mechanism, such as a utility button (202) or an icon (203) displayed on the touch screen display (102), which is programmed to resize the touch screen keyboard (300). A variety of other methods of issuing this command could also be used, such as the user making a specific stroke on the touch screen display (102) with a pointing device (201, FIG. 1).

As shown in FIG. 3, the touch screen keyboard (300) is preferably oriented along the length or longer side of the touch screen display (102) to better accommodate the dimensions of the touch screen keyboard (300). Therefore, as shown in FIG. 3, the tablet computer (100) is rotated 90 degrees so that the touch screen keyboard (300) can be used with both of the user's hands in a standard typing position.

FIG. 3. also shows an additional embodiment of the present invention which entails a text display window (301) that is displayed on the touch screen display (102) in conjunction with the display of the touch screen keyboard (300). The text display window (301) displays or echoes the text that is typed into the tablet computer (100) via the touch screen keyboard (300). The user can then, for example, view, edit, manipulate, save, index, and search the input text inside the text display window (301) or perform any other function that could be performed in standard operation of the tablet computer (100).

Because some tablet computers (100) might not be able to accept the pace of input achieved by standard typing via a touch screen keyboard (300), an additional embodiment of the present invention entails a method and system of accepting text that is typed into the tablet computer (100) via a touch screen keyboard (300). For example, a buffer, an additional processor dedicated to accepting text that is input from the touch screen keyboard (300), or a combination of a buffer and a processor could be used to realize this embodiment.

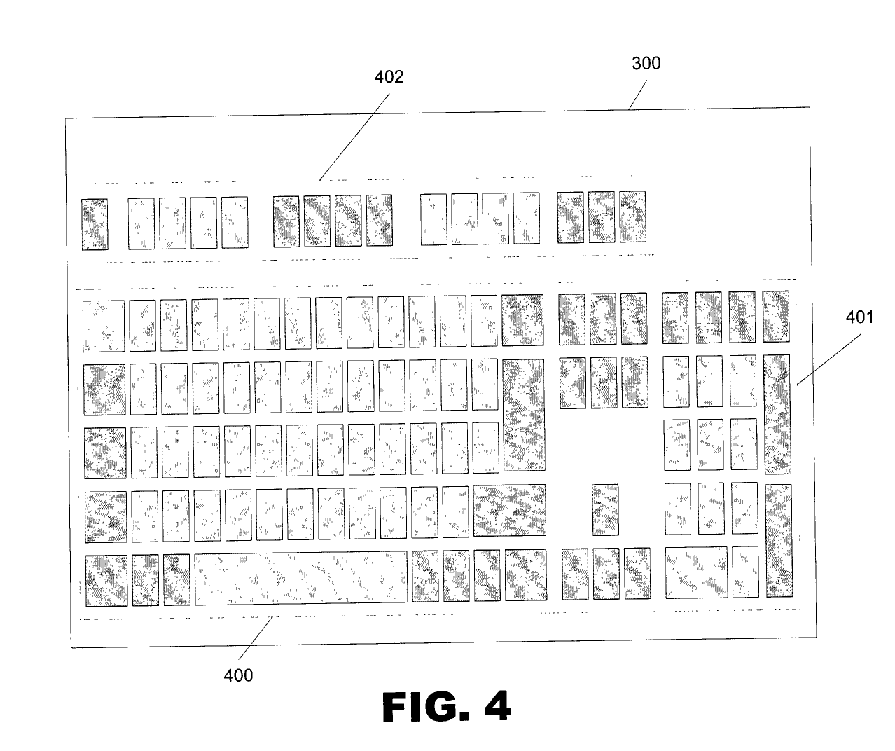

FIG. 4 shows a preferred embodiment of a touch screen keyboard (300). As shown in FIG. 4, a touch screen keyboard (300) preferably consists of standard alphabetic keys (400), a number pad (401), and function keys (402). The standard keys (400) could be the keys that are found on a typewriter or conventional keyboard, for example. The number pad (401) could consist of the numbers 0 through 9 as well as the basic mathematical operation keys (e.g.; addition, subtraction, multiplication, and division). The function keys (402) could consist of the F1 through F12 function keys, the escape key, the control key, and other functional keys found on standard personal computer keyboards. However, the touch screen keyboard (300) could also consist of additional or different keys, depending on the application.

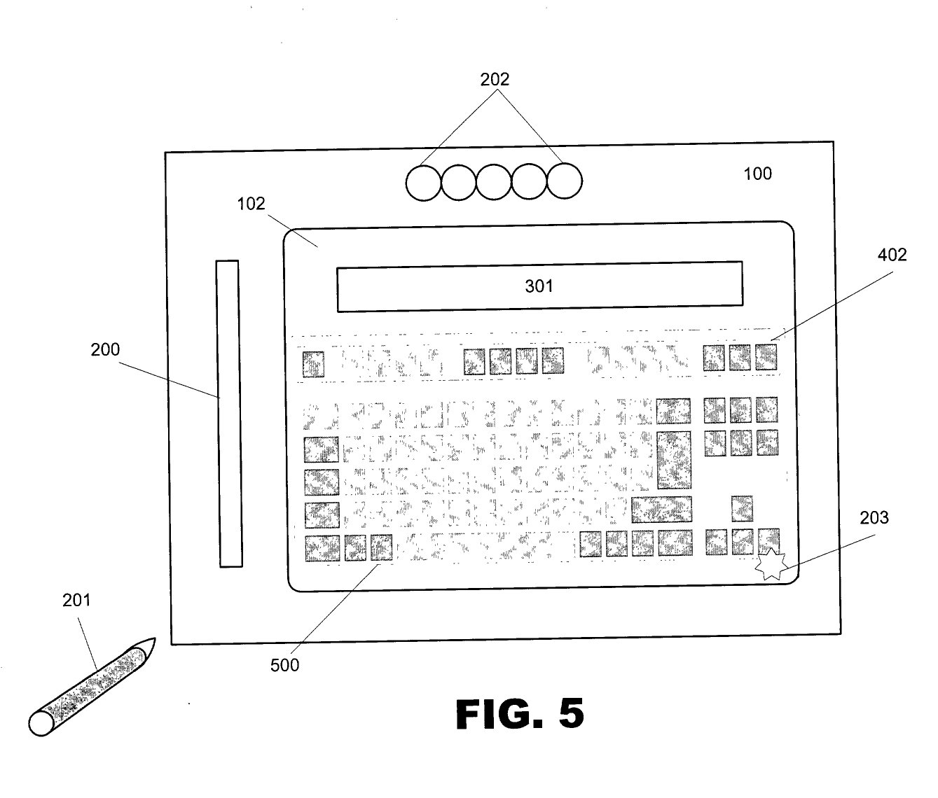

An alternate embodiment is shown in FIG. 5. In this case, the number pad (401, FIG. 4) has been removed from the touch screen keyboard (300, FIG. 4) to make room for an expanded touch screen keyboard (500) in which the letter keys are bigger and easier to use. The user can select this option if the number pad (401, FIG. 4) is not needed. Selecting which groups of keys to hide or display can be performed by selecting a control mechanism (e.g., pressing a utility button (202) or selecting an icon (203) on the touch screen display (102)) or by making a particular stroke on the touch screen display (102) with a pointing device (201). Any other group of keys, such as the function keys (402), could also be removed to provide more room in which to enlarge the other keys.

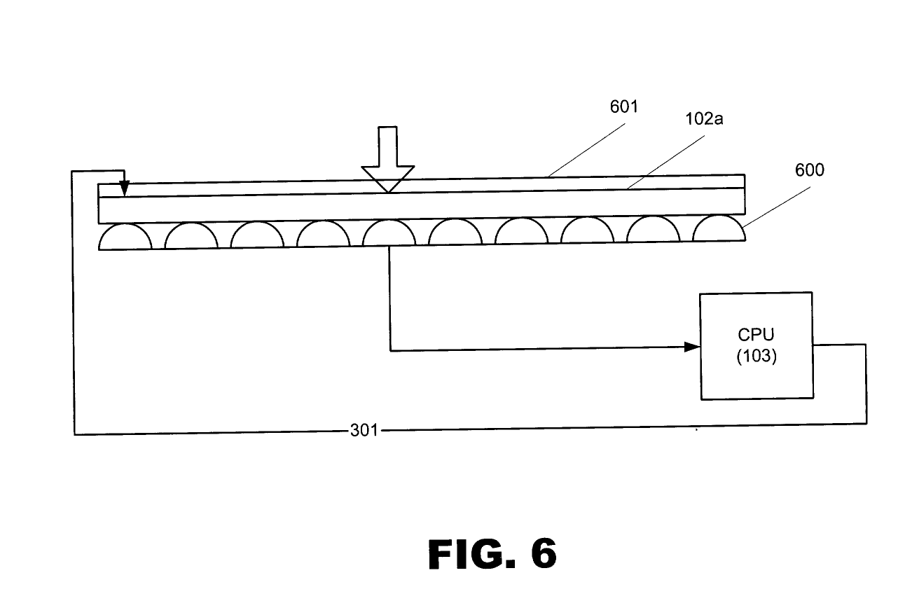

The present invention includes an embodiment that does not include a touch screen. In a possible embodiment, as shown in FIG. 6, keyboard pads (600) are placed under the surface of a display (102a). The display (102a) may be, for example, a liquid crystal display (LCD). FIG. 6 is a side view of a display (102a) with keyboard pads (600) placed underneath the touch screen display (102). When the image of a keyboard (300; FIG. 3) is displayed, the keyboard pads (600) sense which key is pressed.

When using the embodiment of FIG. 6, the user selectively applies pressure to the key images on the display (102a). This pressure results in deflection of the display (102a) and pressure being applied to one of the keyboard pads (600) that are underneath the surface of the display (102a). Pressure on a keyboard pad (600) signals to the CPU (103) which key has been pressed on the image of a keyboard on the display (102a). The CPU (103) then displays the desired character on the display (102a) in the text display window (301; FIG. 5).

As shown in FIG. 6, a clear plastic layering (601) or any other protective device could be placed on top of the display (102a) to keep fingerprints or other smudge marks off the display (102a). This layering (601) can be used in any embodiment.

The preceding description has been presented only to illustrate and describe the invention. It is not intended to be exhaustive or to limit the invention to any precise form disclosed. Many modifications and variations are possible in light of the above teaching.

The preferred embodiment was chosen and described in order to best explain the principles of the invention and its practical application. The preceding description is intended to enable others skilled in the art to best utilize the invention in various embodiments and with various modifications as are suited to the particular use contemplated. It is intended that the scope of the invention be defined by the following claims.

What is claimed is:

1. A tablet computer, said tablet computer comprising:
a display that displays an image of a keyboard, said image of said keyboard comprising images of individual keys;
a memory unit that contains a driver for driving said display to display said image of said keyboard; and
a processor that runs said driver for displaying said image of said keyboard.

2. The computer of claim 1, wherein said display comprises a touch screen display.

3. The computer of claim 2, wherein said touch screen display generates a signal in response to a user selecting one of said keys and provides said signal to said processor, wherein said signal indicates which of said keys is selected.

4. The computer of claim 1, wherein said computer further comprises a pointing device for selecting one of said keys.

5. The computer of claim 1, wherein said driver comprises a driver that selectively changes a size of said image of said keyboard.

6. The computer of claim 1, wherein said computer further comprises a control mechanism for signaling to said processor to run said driver, said control mechanism being electrically connected to said processor.

7. The computer of claim 6, wherein said control mechanism comprises an icon displayed in said display.

8. The computer of claim 6, wherein said control mechanism comprises a utility button.

9. The computer of claim 1, wherein said image of said keyboard displayed on said display uses approximately 80 percent of said display.

10. The computer of claim 1, wherein said image of said keyboard comprises an image of a number pad.

11. The computer of claim 1, wherein said image of said keyboard comprises an image of a set of function keys.

12. The computer of claim 1, wherein said display further comprises an image of a window for displaying text, said text being an echo of input through said display and said image of a keyboard.

13. The computer of claim 1, wherein said driver comprises a driver that selectively changes a size of said image of said window in response to user input.

14. The computer of claim 1, wherein said computer further comprises keyboard pads for sensing which of said keys is selected, said keyboard pads being located underneath said display, being registered with said images of said keys, and being electrically connected to said processor.

15. The computer of claim 1, wherein said computer further comprises a protective covering, said protective covering being placed over all or part of said display.

16. The computer of claim 15, wherein said covering is placed over said image of said keyboard displayed on said display.

17. The computer of claim 1, wherein said memory unit comprises a hard drive.

18. The computer of claim 1, wherein said display has a length and a width, and said driver displays said image of said keyboard oriented in a manner such that rows of said keys are aligned parallel with said length.

19. The computer of claim 1, wherein said driver comprises a function that selectively changes a size of said image of said keyboard in response to user input.

20. A method of entering data to a tablet computer, said method comprising:
displaying an image of a keyboard on a display of said computer; and
receiving user input through said image of said keyboard.

21. The method of claim 20, further comprising generating a signal in response to a user selecting a key of said keyboard and providing said signal to a processor, wherein said signal indicates which of said keys is selected.

22. The method of claim 21, further comprising selecting said key of said keyboard with a pointing device.

23. The method of claim 20, further comprising selectively changing a size of said image of said keyboard.

24. The method of claim 20, further comprising signaling to a processor to run a driver that drives said display to display said image of said keyboard.

25. The method of claim 20, further comprising selecting groups of keys of said image of said keyboard to display on said display.

26. The method of claim 20, further comprising displaying on said display an image of a window for displaying text, said text being an echo of input through said display and said image of a keyboard.

27. The method of claim 26, further comprising selectively changing a size of said image of said window.

28. The method of claim 20, further comprising sensing which keys of said keyboard are selected with keyboard pads, said keyboard pads being located underneath said display, being registered with said keys.

29. The method of claim 20, further comprising protecting all or part of said display with a protective covering.

30. The method of claim 20, wherein said display has a length and a width, said method further comprising displaying said image of said keyboard oriented such that rows of keys are aligned parallel with said length.

31. A system for entering data to a tablet computer, said system comprising:
means for displaying an image of a keyboard on a display of said computer; and
means for receiving user input through said image of said keyboard.

32. The system of claim 31, further comprising means for generating a signal in response to a user selecting a key of said keyboard and providing said signal to a processor, wherein said signal indicates which of said keys is selected.

33. The system of claim 32, further comprising means for selecting said key of said keyboard with a pointing device.

34. The system of claim 31, further comprising means for selectively changing a size of said image of said keyboard.

35. The system of claim 31, further comprising means for signaling to a processor to run a driver that drives said display to display said image of said keyboard.

36. The system of claim 31, further comprising means for selecting groups of keys of said image of said keyboard to display on said display.

37. The system of claim 31, further comprising means for displaying on said display an image of a window for displaying text, said text being an echo of input through said display and said image of a keyboard.

38. The system of claim 37, further comprising means for selectively changing a size of said image of said window.

39. The system of claim 31, further comprising means for sensing which keys of said keyboard are selected with keyboard pads, said keyboard pads being located underneath said display, being registered with said keys.

40. The system of claim 31, further comprising means for protecting all or part of said display with a protective covering.

41. The system of claim 31, wherein said display has a length and a width, said system further comprising means for displaying said image of said keyboard oriented such that rows of keys are aligned parallel with said length.

42. The system of claim 31, further comprising means for selectively changing a size of said image of said keyboard.
